(19) United States
(12) Patent Application Publication
(10) Pub. No.: US 2003/0213646 A1
(43) Pub. Date: Nov. 20, 2003

(54) Support bracket for ladder

(76) Inventor: Gerald L. Gallion, Sun Valley, ID (US)

Correspondence Address: PEDERSEN & COMPANY, PLLC, P.O. BOX 2666, BOISE, ID, 83701, US

(21) Appl. No.: 10/419,452

(22) Filed: Apr. 17, 2003

Related U.S. Application Data
(60) Provisional application No. 60/374,283, filed on Apr. 22, 2002.

(51) Int. Cl. E06C 7/00

(52) U.S. Cl. 182/129

(57) ABSTRACT

A ladder attachment for supporting items of various sizes upon a ladder step for storage and/or manipulation comprises a bracket for retaining the items and a mechanism for securely mounting on a ladder step. Preferably, the bracket and mounting system are manufactured as a single, integral unit with no moving parts that may be simply and conveniently moved between different ladder steps and work sites. In the preferred apparatus, front and rear panels define an opening for receiving and retaining various items with an approximately V-shaped cross section. To mount the apparatus to a ladder step, a hook adapted to receive and substantially surround a ladder step is preferably lowered over the desired step and made more secure by the weight of the apparatus and/or the load.

### DESCRIPTION

This application claims priority from U.S. Provisional Patent Application Serial No. 60/374,283, entitled “Buddy, a Cutting Holder, Ladder Friendly,” filed on Apr. 22, 2002, the disclosure of which is herein incorporated by reference.

### BACKGROUND OF THE INVENTION

1. Field of the Invention

This invention relates generally to ladders and ladder accessories. More specifically, this invention relates to a support device for temporarily storing and/or supporting materials at an elevated height upon a conventional ladder.

2. Related Art

For craftsmen and technicians, the use of a ladder is often required to install or repair elevated fixtures and/or structures. In these instances, excessive travel up and down the ladder is both unproductive and undesirable. However, storing materials such as electrical conduit, plumbing pipes, or lumber on a ladder even briefly can be problematic. In addition, in some situations the handling of materials may be simplified if the materials are elevated above the ground. Consequently, several attempts have been made to develop a support device for use with ladders.

In U.S. Pat. No. 2,398,617, M. A. Casey describes a ladder attachment for supporting various items. Casey teaches a pair of forwardly extending, toothed brackets that are mounted to the uprights of a ladder. These brackets are used to support tools, painting supplies, paint pails and the like.

U.S. Pat. No. 3,887,034 (Sawatzky), U.S. Pat. No. 4,184,666 (Boitz) and U.S. Pat. No. 4,318,454 (Johnson) disclose several pipe supporting structures for use with a ladder. Securing a tubular item with these devices requires clamping, wrapping or ratcheting the item to initiate a snug friction-fit between the item and other components of the support device, respectively.

U.S. Pat. No. 4,995,578 (Monheim) depicts a pair of slotted supports for attachment to the stiles of a ladder. These slotted supports are permanently secured to the ladder stiles opposite one another in generally the same plane. The vertically oriented slots allow users to hold various items in an elevated position; however, the height of these supports may not be conveniently adjusted.

U.S. Pat. No. 6,024,192 teaches a pipe supporting device which may be clamped to a ladder at any height. Several independent clamping units must be loosened or tightened as necessary to secure tubular items such as electrical conduit within the device. These moving parts must be properly maintained to ensure safe and reliable operation.

There remains a need for a simple support apparatus for use in conjunction with a ladder that is capable of holding items in an elevated position for temporary storage and/or manipulation. This invention addresses the need for a convenient, portable and stable support device with no moving parts.

### SUMMARY OF THE INVENTION

The present invention is a support apparatus for supporting items of various sizes and shapes. According to the present invention, building materials and other articles may be placed temporarily at the level of a ladder step by means of the support apparatus. In some cases, the invention may be mounted on other structures such as, for example, railings or ledges for supporting various items. The apparatus may be particularly suited to handle items of awkward dimensions such as electrical conduit, plumbing pipe, and lumber, yet many other applications are foreseeable. The support apparatus safely and effectively retains items upon a ladder to minimize or eliminate the amount of travel required to retrieve and/or work on materials while installing or repairing elevated structures or systems. Also, the support apparatus holds and preferably grips the material held therein, for safe control and manipulation during cutting of, or other work on, the material.

The support apparatus of the present invention comprises a support bracket preferably integral with a set hook for receiving various items and attaching the apparatus to a ladder, respectively. Preferably, the integral unit is both simple and lightweight so that it can be easily raised or lowered between ladder rungs and/or moved to different work sites. The support apparatus may be manufactured as a single unit or the individual components may be produced separately for subsequent assembly. The components of the support apparatus are preferably constructed of rigid, durable materials such as aluminum, steel or hard plastic.

In the preferred embodiment, the support bracket comprises an essentially V-shaped receiving space formed between front and rear panels arranged at an angle to each other. Various dimensions may be used for the front and rear panels, and various angles may be provided between said front and rear panels, to adapt the support bracket for use with different diameters, dimensions, and shapes. Preferred front and rear panels are arranged at an acute angle for supporting items having at least one dimension not significantly greater than 5½ inches. The interior of the support bracket comprising the receiving space between the panels may be textured with, for example, a rubber mat, to improve the gripping ability of the bracket. Other parts of the support apparatus may also be textured if desirable.

In the preferred embodiment, a generally U-shaped (inverted) set hook integral with the bracket slides over a ladder step to attach the support apparatus to a conventional ladder. Preferably, the hook fits snugly between the ladder uprights and rests firmly atop the ladder step to stabilize the apparatus against horizontal and vertical motion. With the set hook positioned on the ladder step, the rear panel of the V-shaped support bracket contacts the ladder uprights, and/or the step below the step on which the set hook is installed, to brace the support apparatus against rotation around the step on which the set hook is installed.

### BRIEF DESCRIPTION OF THE DRAWINGS

FIG. 1 is a perspective view of one embodiment of the invented support apparatus.

FIG. 2 is a side cross sectional view of the support apparatus of FIG. 1.

FIG. 3 is a side cross sectional view of the support apparatus of FIG. 1 showing an item with circular cross section retained within the support bracket.

FIG. 4 is a top view of the preferred embodiment of the support apparatus showing a notch carved out of the bracket base.

FIG. 5 is a side view of the preferred support apparatus of FIG. 4 mounted on the step of a ladder.

FIG. 6 is a perspective view of the preferred support apparatus of FIGS. 4 and 5 shown mounted on a conventional ladder.

FIG. 7 is a front view of the support apparatus of FIGS. 4-6 shown mounted on a conventional ladder and supporting a long, thin item within the support bracket.

FIG. 8 is a front perspective view of an embodiment of the invented support apparatus on the lowermost step of a ladder, with the bracket assembly resting against the lower portions of the ladder uprights and the support apparatus supporting a wall panel.

### DESCRIPTION OF THE PREFERRED EMBODIMENTS

Referring now to the figures, some, but not all, of the several foreseeable embodiments of the invented support apparatus for a conventional ladder are presented. The invented support apparatus simply and securely attaches to a ladder step, or other rails or stable structure, to temporarily retain items for storage and/or manipulation. The support apparatus minimizes or eliminates the need for workers to travel up and down a ladder repeatedly while installing or repairing elevated fixtures and/or structures. The support apparatus also supports and secures an item being worked on, for example, by cutting, grinding, drilling, or other work. Thus, materials held in the support apparatus may be cut, drilled, or otherwise manipulated, or displayed or stored, in several elevated positions on a ladder corresponding to the several steps of the ladder. The support apparatus is preferably manufactured as a single, lightweight unit, with no moving parts that may be easily moved between steps or work sites, or that may be used on devices other than ladders.

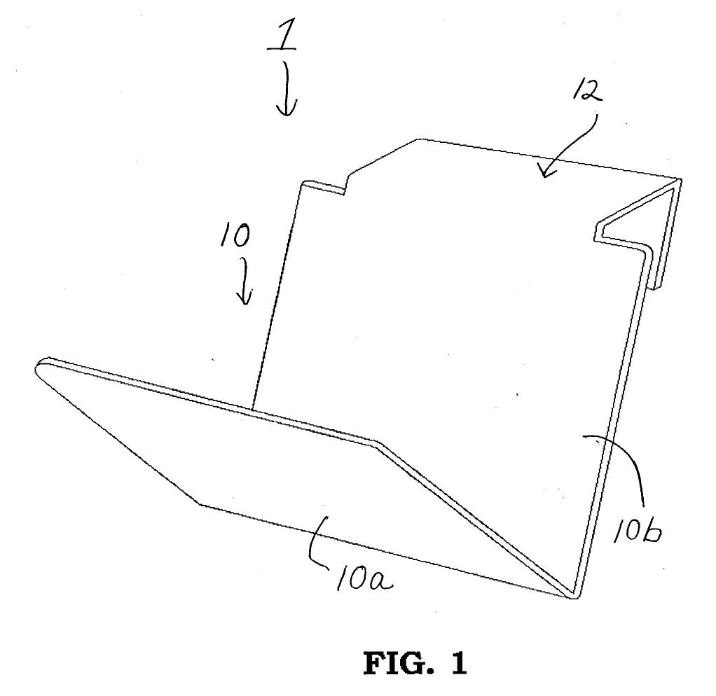

As shown in FIG. 1, the invented support apparatus 1 preferably comprises an integral bracket 10 and set hook 12. The bracket 10 is configured to receive various items for storage or manipulation and the set hook 12 is adapted to securely, but releasably, attach the support apparatus to a conventional ladder. In the preferred embodiment, the bracket is generally V-shaped and the set hook is generally U-shaped with the openings of the bracket and hook being vertically opposed so that the bracket faces up and the hook down.

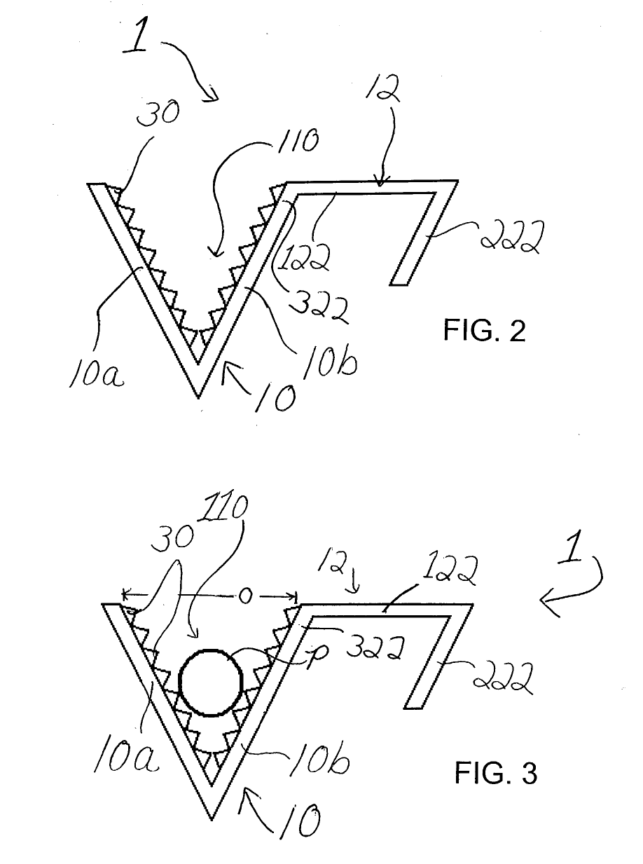

Preferably, the bracket 10 and set hook 12 are molded as a single, seamless unit (apparatus 1) using known manufacturing methods, as shown in FIGS. 1 and 2. For example, to manufacture the integral support apparatus, the bracket and set hook may be injection molded or a single, flat panel may be bent into the proper form. However, alternative configurations and methods of assembly may be possible so long as the function of the support apparatus is not compromised. For example, the bracket 10 and hook 12 may be formed separately and subsequently assembled via welding.

As shown in FIG. 1, the support bracket 10 preferably comprises a generally V-shaped receiver formed between front 10a and rear 10b panels. Preferably, the front 10a and rear 10b panels are joined at an acute angle, for example, an angle in the range of 35-55 degrees, such as the embodiment shown in FIGS. 2, 3, and 5. The V-shaped bracket allows items of various dimensions and shapes to be wedged securely between the forward 10a and rear 10b panels under their own weight or under manually applied pressure. The support apparatus may be particularly suited for use with cylindrical items. For example, electrical conduit or plumbing pipe P may be placed into, and held within, the receiving space 110 of the bracket, as shown in FIG. 3, and, due to the V-shape receiving space, items of many different diameters may be supported and “wedged” into the V-shape. Preferably, the receiving space of the bracket 10 is designed such that items with at least one dimension less than about 5½ inches may be supported. In the preferred embodiment, cylindrical items with diameters on the order of less than or equal to 5½ inches and other objects with at least one dimension slightly less than the largest opening of the bracket (O in FIG. 3) may be held in the support apparatus.

Methods of supporting differently-shaped building materials and items on the invented support apparatus 1 are possible. For example, planar sheets such as wall panels, glass panes, plywood sheets, flooring sheets or tiles, may be supported in embodiments of the support apparatus 1. Angled, square-angled, cylindrical, and other shapes of items may also be supported. Even flexible items may be supported in the apparatus 1, and may be cut or otherwise worked-on, for example, by pressing a rigid block (not shown) down upon the item in the support apparatus 1 to stabilize the item and prevent it from bending under the pressure of the cutting or other work. Other embodiments of the support apparatus may include alternative bracket designs, for example, a J-shaped or U-shaped receiving bracket with a curved base, rather than a V-shaped bracket.

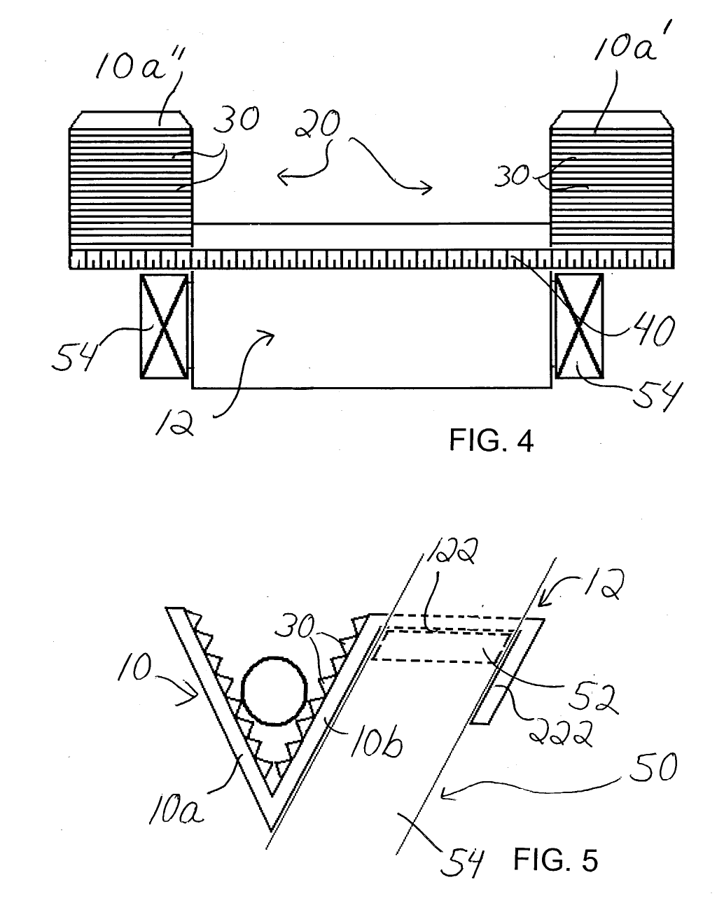

Lighter, more accessible support devices 1 may be designed with portions of the bracket 10 removed. For example, in an especially preferred embodiment, a wide notch 20 is cut away from the base of the bracket or otherwise formed, as shown in FIGS. 4 and 6. This provides a front panel that comprises a left front panel portion 10a′ and a right front panel portion 10a″ separated by the notch 20. This way, users may reach into the support apparatus, at or near the center of the support apparatus, to grasp items retained within the bracket while cutting, drilling or otherwise handling such items. Being able to access the supported item near the center of its portion that is supported by the invented apparatus tends to keep the item balanced and secure in the invented apparatus while the item is being worked on. Further, removing material from the bracket 10 or hook 12 assemblies may also reduce the overall weight of the support apparatus to simplify installation or transport of the device. Any portion of the apparatus 1 may be removed so long as the strength and functionality of the apparatus is not compromised. In some embodiments, holes may be punched in the apparatus or the apparatus may be constructed of a strong and durable wire mesh to minimize its weight.

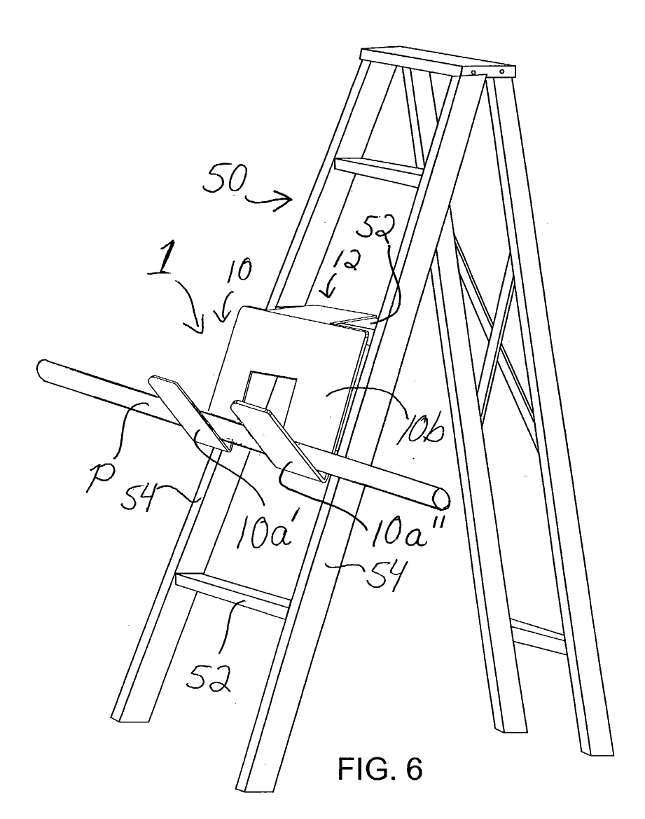

To enhance the gripping capabilities of the bracket 10, the surface of the bracket may be coated with, for example, rubber matting or a tacky substance. Other methods of texturing the bracket surface may also be used. For example, the metal or plastic surface may be scratched, roughened, or ribbed using various instruments or manufacturing methods to reduce the slickness of the apparatus surfaces. In FIGS. 2, 3 and 5, the texturing includes raised teeth 30 of plastic or rubber. While the pipe P is shown resting on the tips of the teeth 30 in FIGS. 3 and 5, embodiments including flexible or rubbery texturing would receive the pipe in its lowest possible position in the bracket receiving space 110 by means of the flexible or rubbery texturing bending or compressing under the weight of the pipe or other item. Texturing of the bracket 10 surfaces may prevent rotation of cylindrical objects within the bracket during manipulation and may provide a more stable gripping platform for some awkwardly shaped items. Other surfaces of the apparatus 1 may also be textured to increase the durability or functionality of the device. For example, the upper and/or lower surfaces of the set hook 12 may be textured to provide a non-slick stepping surface or for improved frictional engagement with the ladder, respectively.

The visible surface of the bracket 10 may also include measurement indicia, warning labels or other helpful markings. For example, a measuring tape 40 may be stamped or painted on the bracket surface to allow users to measure items held in the bracket prior to cutting or installing, as shown in FIG. 4.

In the preferred embodiment, the support apparatus 1 is connected to a ladder 50 by sliding the set hook 12 over a ladder step 52, as shown in FIGS. 5 and 6. In other embodiments, the support apparatus may be adapted to mount upon other stabilized structures such as, for example, the seat back of a chair, car seat, or a railing. The dimensions and/or shapes of the hook and bracket assemblies may be adjusted to accommodate such structures. However, the same, or a substantially similar, support apparatus configuration preferably mounts universally across all the steps of a ladder and across various stable platforms.

For those embodiments mounted on a ladder, the set hook is approximately L-shaped (if you include only the top member 122 and the lip member 222) or approximately U-shaped (if you also include the upper region 322 of the panel lob). The set hook fits over the step 52 between the laterally opposed uprights 54 of the ladder 50. The inverted U-shaped hook surrounds the ladder step to securely mount the apparatus to a conventional ladder. In the preferred embodiment, the hook surrounds the step to the extent that at least three sides (front, top, and rear) of the step are in firm contact with the hook. Preferably, the hook 12 conforms to the dimensions of a standard size ladder so that the hook wraps tightly around the ladder step 52 and fits snugly between the ladder uprights 54. However, the opening of the hook may be slightly oversized and the width of the hook slightly undersized to accommodate a variety of ladder sizes. The hook wraps around the step with the base of the “U” (top member 122) resting upon the ladder step to counteract downward forces when a load is applied to the support apparatus 1. Preferably, the bracket 10 is wider than the ladder so that a portion of the rear panel 10b rests against the uprights 54 of the ladder to brace the apparatus 1 against rotation about the step 52. Optionally, portions of the rear panel 10b may extend down an appropriate amount and in an appropriate location to rest against the next lower step, for example, as shown in FIG. 6.

To install the support apparatus 1 on a ladder 50, the assembly is lifted to the desired level and the set hook 12 is slid between the uprights 54 of the ladder and lowered onto the appropriate ladder step 52. The top member 122 preferably extends across and is parallel to the top surface of the ladder step 52. The lip member 222 preferably extends downward along the rear edge of the step 52 to prevent the support apparatus 1 from accidentally being pulled, or falling, forward off of the step. The preferred top member 122 connects the upper region 322 of the rear panel 10b and the lip member 222 so that the panel 10b and lip member 222 are parallel and/or in other relationships adapted to properly hang the set hook 12 on a step or other structure. Thus, the ladder attachment hangs from the ladder step as shown in FIG. 6, and preferably may properly fit and hang from several or all of the ladder steps. For example, by installing the support apparatus 1 on one of the upper steps, as shown in FIG. 6, the worker may reach the item(s) supported in the apparatus 1 and, with one hand, hold the item(s) in the apparatus 1 and, with the other hand, cut the item(s) to a desired length. Because such cutting may be done without supporting the item on the floor, a countertop, or other building surface, there is little or no risk of marring, cutting, or otherwise marring building surface. Also for example, the support apparatus 1 may be installed on one of the lower steps, as shown in FIG. 8, and a tall item such as plywood, glass pane, or wall panel W may be inserted into the apparatus 1 and leaned against the upper region of the ladder.

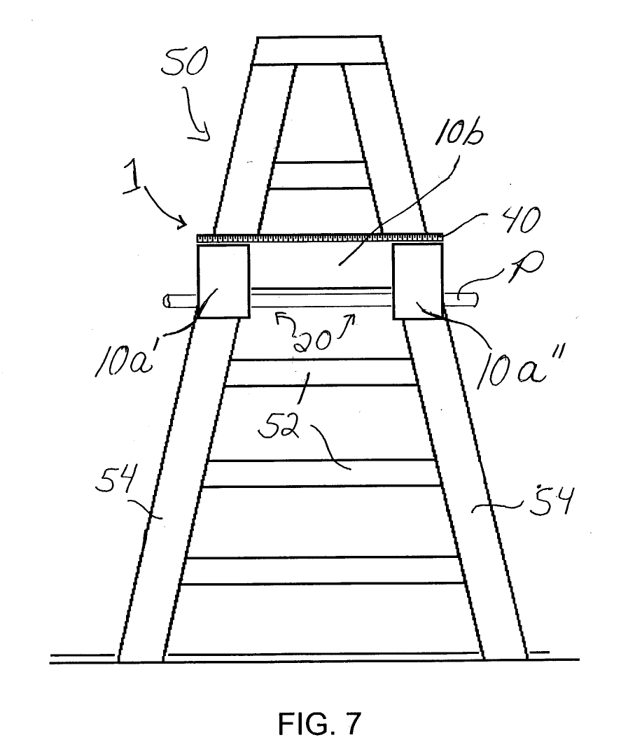

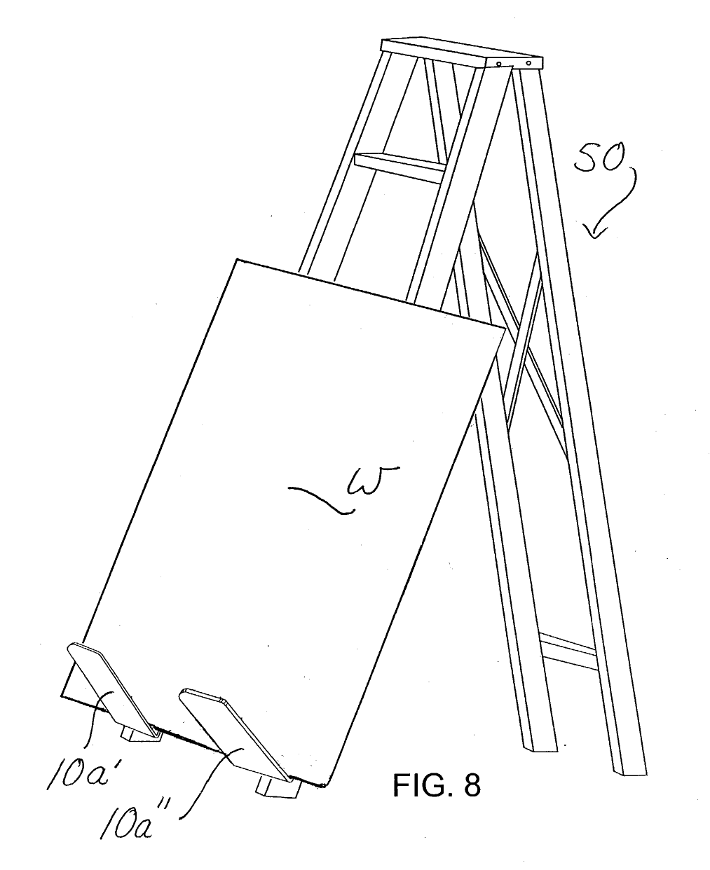

Typically, the weight of the support apparatus is sufficient to secure the device to the step so that additional clamping or adjustment means are not required. However, if necessary, tightening mechanisms may be implemented to strengthen the attachment. Properly loading the bracket 10 by placing or pressing objects into the V-shaped receiving space, and generally centering elongated objects in the bracket 10, promotes a more stable attachment between the step and hook. When the bracket is loaded as shown in FIG. 7, the various components of the support assembly 1 distribute horizontal, vertical and rotational forces across the ladder step 52 and ladder uprights 54. For installation on, for example, seat backs or railings, the hook hangs similarly from the subject stable structure.

The preferred support apparatus may also be used to support a portion of an item that is also supported by the floor or other device. For example, a long, heavy pipe may have one end resting on the floor and the other end received in and supported by a support apparatus 1 on a ladder, so that the pipe rests at an angle to the ground. In this scenario, the support apparatus 1 may tilt sideways on the ladder step, while still remaining hooked on the step, enough to securely hold the pipe for cutting or other work. Also, a long item may be supported with its two ends in two support apparatus 1 on two different, spaced-apart ladders.

The preferred support apparatus may remain on a ladder, even when the ladder is folded for storage, because there is preferably no support apparatus structure that extends rearward or sideways from the rear edge of the step to an extent that will interfere with folding of the ladder. Likewise, the support apparatus may be installed on an extension ladder, and may remain on the extension ladder during storage of the ladder.

The preferred support apparatus is symmetrical, for either right-handed or left-handed use. Also, the apparatus is molded, buffed, or otherwise formed or machined to have non-cutting, non-marring, and safe edges and rounded, safe corners. Because the apparatus preferably has no moving parts, no bolt-on or screw-on clamping means, and no adjustment means for altering the shape or position of the apparatus, installation and use of the support apparatus is simple and quick.

The preferred V-shape bracket of the support apparatus includes front and rear panels joined together, preferably rigidly and immovably, at an angle appropriate for the items being supported. For many items typically used in the building and plumping trades, the preferred angle is acute, and typically in the range of about 35-80 degrees and especially in the range of 35-55 degrees. However, many other angles, and even obtuse angles may be effective. For example, acute angles are particularly useful for elongated cylindrical pipes, angle-iron, and panels. Obtuse angles in the range of 90 to about 120 degrees may be operable for large-diameter or bulky items, but care should be taken to keep the center of gravity of the ladder, support apparatus, and item combination in a location that will not allow easy tipping of the ladder, and to provide a size and shape of bracket that will not allow the item to roll out of the bracket.

Although this invention has been described above with reference to particular means, materials and embodiments, it is to be understood that the invention is not limited to these disclosed particulars, but extends instead to all equivalents within the scope of the following claims.

I claim:

1. A support apparatus for retaining building materials and other items, the support apparatus being adapted to releasably mount on stable structure such as a ladder step, seat back or railing and the support apparatus comprising:
a bracket assembly with a V-shaped opening for receiving items; and
a hook assembly adapted to receive and surround at least a portion of said stable structure, the hook assembly being configured to conform to the contours of said stable structure so that at least three surfaces of said stable structure are contacted by said hook assembly to hold said hook assembly in place on said stable structure;
wherein said bracket assembly is integral with said hook assembly.

2. A support apparatus according to claim 1, wherein the hook assembly is adapted to receive and surround a ladder step.

3. A support apparatus according to claim 1, wherein the bracket assembly comprises textured surfaces.

4. A support apparatus according to claim 1 wherein the bracket assembly and hook assembly comprise textured surfaces.

5. A support apparatus according to claim 4 wherein said textured surfaces comprise an element selected from the group consisting of rubber matting, films of tacky substances, hard plastic ribbing, scratched surfaces, and roughened surfaces.

6. A support apparatus according to claim 1 comprising no moving part to attach said support apparatus to said stable structure.

7. A support apparatus according to claim 6 comprising no screw or bolt means for attaching to said stable structure.

8. A support apparatus for retaining building materials and other items adapted to mount on a stable structure such as the step of a conventional ladder, a seat back or a railing, the support apparatus comprising:
a panel molded or bent to form a bracket integral with a hook wherein orientation of said bracket and said hook are vertically opposed to one another so that the bracket opens upward and the hook down and wherein the bracket comprises walls defining an interior space adapted to receive and retain items and said hook is adapted to receive and surround said stable structure, the hook being configured to conform to the contours of said stable structure so that at least three surfaces of said stable structure are contacted by said hook to hold said hook in place on said stable structure.

9. A support apparatus according to claim 8, wherein the hook is adapted to contour to three surfaces of a ladder step.

10. A support apparatus according to claim 8 wherein the surfaces of the bracket and hook are textured.

11. A support apparatus according to claim 10 wherein said surface texturing comprises an element selected from the group consisting of rubber matting, thin films of tacky substances, hard plastic ribbing, scratched surfaces, and roughed surfaces.

12. A support apparatus according to claim 9 wherein the apparatus requires no moving parts to attach to said ladder step.

13. A support apparatus for retaining building materials and other items, the support apparatus adapted to mount on a stable structure such as the step of a conventional ladder, a seat back or a railing, the support apparatus comprising:
a bracket integral with a hook, wherein the orientations of said bracket and said hook are inverted relative to one another and wherein the bracket is adapted to receive and retain items within a space between its walls and said hook is adapted to receive and surround at least a portion of said stable structure, the hook being configured to conform to the contours of said stable structure so that at least three surfaces of said stable structure are contacted by said hook to hold said hook in place on said stable structure; and
wherein the bracket and hook are injection molded as a single unit.

14. A support system for holding an item on a ladder, the support system comprising:
a ladder having a step; and
a support apparatus for receiving an item and comprising a hook portion adapted to hook over the step, and a bracket portion extending from the hook and having an upwardly-opening space for releasably holding an item to be worked on;
wherein the support system comprises no bolt-on or screw-on and no clamp-on means for attaching the support apparatus to the step other than the hook portion extending over and gripping onto the step.

15. A support system as in claim 14, wherein the hook portion is an upside-down U-shape and the bracket portion is a V-shape.

16. A support system as in claim 14, wherein the bracket portion comprises a rear panel and a front panel rigidly joined together at an angle in the range of 35-55 degrees.

17. A support system as in claim 14, wherein the bracket portion comprises a rear panel and a front panel comprising a right panel portion and a left panel portion rigidly joined to the rear panel with a space between the right panel portion and the left panel portion for access of a user to the item received in the support apparatus.
